(19) United States
(12) Patent Application Publication
(10) Pub. No.: US 2004/0024803 A1
(43) Pub. Date: Feb. 5, 2004

(54) Cascaded modified PRBS counters form easily programmed and efficient large counter

(76) Inventor: Allen Montijo, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/210,026

(22) Filed: Jul. 31, 2002

(51) Int. Cl. G06F 7/58; G06F 7/42

(52) U.S. Cl. 708/494; 708/505

(57) ABSTRACT

An IC may be provided with an efficient programmable counter that affords speed, modest size, low power consumption and easy programmability, by cascading a number of PRBS counters modified to include the all-zeroes state, so that they have a full 2ⁿ different states for n-many flip-flops in the counter. For example, a forty-bit counter can be formed by cascading five eight-bit PRBS counters that have each been modified to have 2⁸=256 different states. The result is a fast forty-bit counter that is of modest power consumption and nearly minimal device count, and yet is nearly as easy to program as a standard binary counter.

### BACKGROUND OF THE INVENTION

Some types of electronic test equipment make use of counters for various purposes. Sometimes these counters are quite large, say forty bits, and need to be programmable for use as down counters or as frequency dividers. It is presently typical that such test equipment makes extensive use of VLSI ICs (Very Large Scale Integrated Circuits). It is desirable such a forty bit (or even larger) programmable counter be included in such VLSI ICs although one can easily imagine that perhaps it ought to be fabricated separately on its own IC. Either way, the issues of power consumption, speed and amount of silicon all combine to influence the cost and practicality for any given application within a system.

Various counter designs are known, but in the realm of those that count to large values (say, forty bits or about 1012) it is typical that a design that performs well in one area has substantial disadvantages in others that may well be equally important. A four or eight bit counter architecture that works in the Giga Hertz range may fail to maintain its speed at forty bits, and may, at forty bits, present significant obstacles to convenient programming. For example, standard binary counters are relatively easy to program, have the least number of flip-flops and a moderate number of gates, but typically have timing problems at high speeds, owing to some lengthy paths for gated signals. One-hot counters reduce the numbers of gates in the various signal paths and can count fast, but at the expense of a very considerable increase in the number of flip-flops. PRBS (Pseudo Random Binary Sequence) counters are attractive in terms of both number of flip-flops (minimal) and number of gates (low), so they can count fast and be efficient in terms of power consumption and chip real estate. However, they typically have a significant disadvantage in connection with programming.

There are two reasons for this disadvantage. First, while it is not difficult to actually force the individual bits to particular values, it can be quite troublesome to discover what those values ought to be for a desired count. It is a pseudo random counter, after all, and some count value k for the counter is not simply k expressed in binary! Instead, there is some other pattern of bits that we must discover. In general, there are only two ways to do this. One is through the use of a look up table. For eight-bit (or perhaps even sixteen-bit) counters this may be an acceptable solution, but it is almost unimaginable to contemplate such a table for forty bits. That leaves the use of a formalized arithmetic relationship that describes the behavior of that particular counter. That is, we must arrive at the result analytically, through the manipulation or solution of the particular polynomial that is embodied by the counter. For small counters that is practical, but can easily become complicated and error prone as the size of the counter increases.

“Divide and Conquer” is a strategy that is often tried in situations like this. Not only does that turn out be a bad pun (read on), but it turns out to have its own troubles. Suppose we decide to cascade a number of smallish PRBS counters to keep their individual housekeeping issues manageable. Programming an internal PRBS counter element within a cascaded sequence of such PRBS counters involves integer divisions and modulo operations using the (forty-bit) number to programmed into the entire cascaded counter and the (maximum) number of counts counted by the internal (eight-bit) component counters. Unfortunately, PRBS counters are conventionally arranged to disallow the all zero state. This means that for n-many bits they only operate over 2ⁿ−1 different states (counts). So, for example, in N were the number to be programmed into a forty-bit counter formed of five such cascaded eight-bit counters, the least significant (fastest counting) counter would be set to N mod 255. The next counter over gets (N div 255) mod 255, where “div” is integer division. The third counter gets ((N div 255) div 255) mod 255=(N div 255²) mod 255. The fourth counter gets (N div 255³) mod 255, while the most significant counter is programmed to N div 255⁴ (a final mod 255 is not needed, since if it were, N would extend beyond the range of that final counter section!). All these operations involving 255 are time consuming and pretty disgusting compared to a much preferable divide by 256 or mod 256, which involve a nice power of two, and can be accomplished simply by masking and the shifting of bits.

It would be desirable, then, if there were an architecture for a programmable counter of many bits that lent itself to convenient programming, retained the ability to count at adequate speeds, was economical in terms of silicon consumption (number gates, devices, etc.), and that had moderate to low power consumption.

### SUMMARY OF THE INVENTION

A solution to the problem of providing an IC with an efficient programmable counter that affords speed, modest size, low power consumption and easy programmability, is to cascade a number of PRBS counters modified to include the all-zeroes state, so that they have a full 2ⁿ different states for n-many flip-flops in the counter. For example, a forty-bit counter can be formed by cascading five eight-bit PRBS counters that have each been modified to have 2⁸=256 different states. The result is a fast forty-bit counter that is of modest power consumption and nearly minimal device count, and yet is nearly as easy to program as a standard binary counter.

### BRIEF DESCRIPTION OF THE DRAWINGS

FIG. 1 is a simplified block diagram of a programmable forty-bit counter formed from five cascaded eight-bit PRBS counters modified to allow for easy programming; and

FIG. 2 is a simplified block diagram of the programmable eight-bit PRBS counters used in FIG. 1.

### DESCRIPTION OF A PREFERRED EMBODIMENT

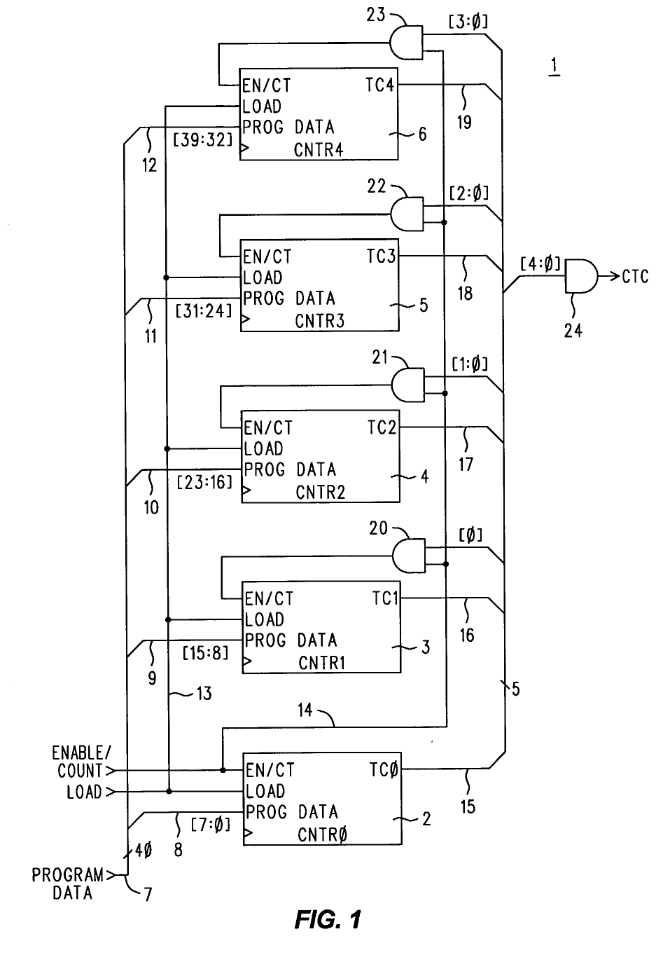

Refer now to FIG. 1, wherein is shown a simplified representation 1 of a programmable forty-bit counter formed by five eight-bit programmable modified PRBS counters shown as CNTR0 through CNTR4 (2-6). The forty-bit value (7) to be programmed in is partitioned into respective segments 8-12 that represent consecutive eight-bit segment of the forty bits, and that are each individually applied to their associated counter (2-6, respectively). All counters load their value upon the assertion of a signal LOAD 13, which is supplied to each of the eight-bit PRBS counters 2-6.

Each of the modified eight-bit PRBS counters has a terminal count, which is just one particular count in its sequence, say 00000001. The terminal count is detected by a gate internal to the counter, and its occurrence is indicated by signals TC0 through TC4 (15-19, respectively). In keeping with the cascaded arrangement of the counters, CNTR0 counts fastest, CNT4 slowest, and when, say, counting down to a terminal count from some pre-programmed value, TC0 can be expected to come and go 256 times faster than TC1, which cycles similarly faster than TC2, and so on. The terminal count for the entire cascaded counter arrangement is detected by AND gate 24, whose output is a signal CTC (Counter Terminal Count)that is generated when all the terminal count signals (CT0/15-CT4/19) are also TRUE.

In a similar vein, note how the AND gates 20-23 arrange for the counters to count in cascaded fashion. Each counts when it receives a signal called ENABLE/COUNT. (Which is really the same signal for each of two modes of operation: as a steady gate-like ENABLE for consecutive counting as a timer; and as an as-needed pulse for counting events as they occur.) An ENABLE/COUNT signal 14 that originates within an outer environment is applied directly to CNTR0 (2). It is also applied as an input to each of AND gates 20-23, whose functions are to allow it to be applied to a next significant section (CNTR2-CNTR4) only when the appropriate terminal count signals (TC0-TC3) of lesser significant sections are present. Finally, a common clock signal (not shown) is continuously applied to each of the counters CNTR0 through CNTR4.

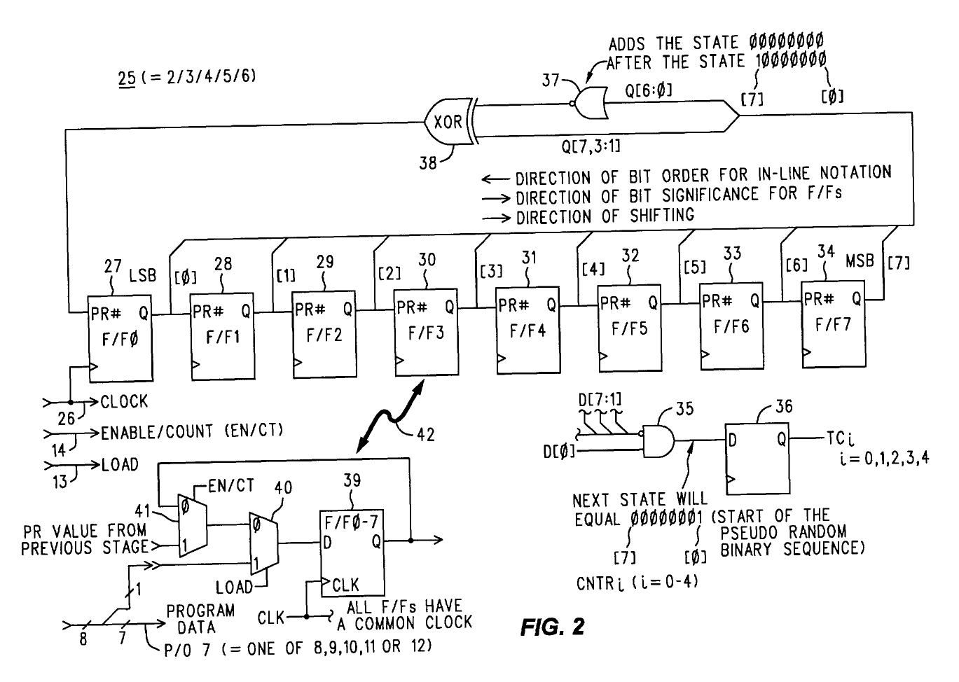

Refer now to FIG. 2, wherein is shown a simplified block diagram of a modified eight-bit PRBS counter 25 that is representative of each of the five such counters 2-6 of FIG. 1. Note that, as stated above, a common clock signal 26 is indeed supplied to each of FF0 through FF7 (27-34), which are also connected serially in shift register fashion: each flip-flop's Q output coupled to the PR# (Pseudo Random Number) input of the next flip-flop, except that FF0's input is formed by gates 37 and 38, rather than taken as just the output from FF7. It is this “randomizing” of the input shifted into FF0 27 that gives the eight-bit counter 25 its PRBS characteristic.

Before turning to the operation of the gates 37 and 38, consider representation of an individual cell (39, 40, 41) of the shift register (25), as indicated by arrow 42. A D-type flip-flop 39 re-circulates its value (expressed at the Q output) back to its input (D) whenever the EN/CT signal 14 is LOW and the signal LOAD 13 is also LOW. The re-circulation takes place, of course, at intervals defined by excursions in the clock signal CLK 26. On the other hand, to shift in the value from the previous stage or the randomized value from the XOR gate 38, the EN/CT signal 14 is asserted while LOAD (13) remains LOW. This action allows MUX 41 to substitute the pseudo random value from the previous stage for the re-circulated value. Furthermore, if LOAD is HIGH, then MUX 40 forces an appropriate value from one of the segments 8-12 of PROGRAM DATA 40 to be the signal whose value is loaded into the D input of flip-flop 39. This arrangement, which is one of having the clock signal continuously applied to the flip-flops, is one that is generally preferred the ASIC (Application Specific IC) business, as it greatly assists in increasing testability.

Note also flip-flop 36. It is set by the TRUE output from a gate 35 that detects that the state being shifted in is 00000001 (the start of the Pseudo Random Binary Sequence—PRBS). That is, that the next state is the terminal count. It is thus that the various terminal count signals TC0-TC4 are generated.

Now but gates 37 and 38. If NOR gate 37 were absent and XOR gate 38 had one less fewer input (the one from NOR gate 37), then the eight-bit counter 25 shown in the Figure would be a completely conventional PRBS counter (and one whose operation we need not explain). The addition of the extra NOR gate 37 will be appreciated as adding the state 00000000 after the state 10000000 in the PRBS value sequence, and then further adding 00000001 as the next state. It adds 00000000 by shifting a ZERO into FF0 when the output of NOR gate 37 is TRUE during when bits [6:0] are all FALSE and while bit [7] is TRUE. It next adds 00000001 by shifting in a ONE, because now bit [7] is no longer TRUE. It will be further appreciated that the addition of such conditions detected by NOR gate 37 in no way disturbs the remaining operation of the counter. This is because bits [6:0] are all but one of the eight bits, leaving the detected condition on bit 7 to be one of only two remaining possibilities, the other of which is already part of the PRBS cycle and which is properly excluded by not being specially detected.

In the preferred embodiment each of the five eight-bit PRBS counters is identical. It will, of course, be appreciated that this is mostly a convenience. The real benefit is not so much that they are identical (which streamlines programming), but that they are readily programmed while operating at speeds greater than those of standard binary counters. They are easily programmed to an individual count and count fast because they have a PRBS architecture. Their individual program-to counts within the cascaded overall count are easy to arrive at because of their identical structure, and because the arithmetic needed is simplified by their each having a sequence is an exact power of two. This latter condition was arrived at, in the example shown, by the addition of the single NOR gate 37 to each of the counters CNTR0 through CNTR4.

Those who wish further details about the disclosed counter may refer now to APPENDIX A and APPENDIX B. These are Verilog listings of these circuits. In bottom-up order, APPENDIX A describes an individual eight-bit counter, while APPENDIX B describes cascading five such counters, all for use as a programmable counter or timer in an ASIC that may be used in a larger environment, such as a digital oscilloscope, logic or timing analyzer, or the like.

[image]

[image]

[image]

[image]

I claim:

1. A counter comprising a plurality of cascaded PRBS counters each of which counts to its full binary capacity.

2. A counter of N=JK-many bits comprising:
J-many identical K-bit PRBS counters cascaded coupled so that each except a least significant counter counts the output of an immediately least significant counter; and
each of the J-many K-bit PRBS counters is identical and each counts 2^{K} many counts.
